(19) United States
(12) Patent Application Publication
(10) Pub. No.: US 2023/0121574 A1
(43) Pub. Date: Apr. 20, 2023

(54) ADJUSTABLE PET BEARING STAND

(71) Applicant: Theresa Gossman, Aberdeen, MD (US)

(72) Inventor: Theresa Gossman, Aberdeen, MD (US)

(21) Appl. No.: 17/966,025

(22) Filed: Oct. 14, 2022

Related U.S. Application Data
(60) Provisional application No. 63/255,527, filed on Oct. 14, 2021.

(51) Int. Cl. A01K 1/035; F16M 11/38

(52) U.S. Cl. CPC A01K 1/0353; F16M 11/38

(57) ABSTRACT

An adjustable pet bearing stand comprising a concave platform. The concave platform includes a perimeter and a depression positioned within the concave platform perimeter wherein a pet can be placed in the depression. The adjustable pet bearing stand includes a support frame comprising a pair of extendable rod sets. Each rod set includes a scissors joint disposed along a portion of the first rod between the first rod upper end. Each rod set includes a locking arm rotatably attached to the first rod between the scissors joint and the concave platform along a locking arm first end and including an arm notch adjacent the locking arm second end opposite the locking arm first end wherein the locking arm secures the support frame in a fixed position when the arm notch is engaged with the second rod between the scissors joint and the concave platform.

### CROSS-REFERENCE TO RELATED APPLICATIONS

“This application claims the benefit of U.S. Provisional Patent Application No. 63/255,527 filed on Oct. 14, 2021, which is incorporated by reference herein in its entirety.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced.

### BACKGROUND OF THE INVENTION

### Field of the Invention

The present invention relates to pet holders and more specifically, to an adjustable pet bearing stand for allowing a pet owner to keep a pet closer to the pet owner when the pet owner cannot pay close attention to the pet.

### Description of Related Art

Dogs, cats, and other pets may enjoy having their owner at home while the owner works from home. Pet owners still need to focus on work, especially during digital meetings with coworkers. Pets may not understand why their owner cannot pay attention to them, ultimately trying to jump on them, bark, etc. during a meeting. Pet owners may lack the ability to make phone calls, go through paperwork, etc. because their pet is in their arms.

In particular there is a need for a pet holder which allows a pet to be near the pet owner so the pet feels comfortable enough to stay docile while the owner is performing other tasks at a desk, table, seat or just standing.

### BRIEF SUMMARY OF THE INVENTION

The instant invention in one form is directed to a platform which allows users with a combination chair and pet bed capable of keeping a pet at reachable heights while an owner works from home.

The adjustable pet bearing stand allows a pet owner to pet and give attention to dogs, cats, and other pets while they are comfortably sitting or lying in the bed.

The adjustable pet bearing stand features scissor-style legs that can be adjusted to a desired height to ensure the bed is at a height where the owner can reach it while sitting in an office chair.

The adjustable pet bearing stand collapses into a compact configuration for storage while the pet bed can be used independently. Offers a way to keep pets off the lap while still providing them with ample attention when working from home.

One aspect of the present invention is directed to an adjustable pet bearing stand comprising a concave platform. The concave platform includes a perimeter and a depression positioned within the concave platform perimeter wherein a pet can be placed in the depression. The concave platform includes a sidewall extending downward from the concave platform perimeter, an underside cavity and a sloped protrusion extending upwardly along a portion of the concave platform. The adjustable pet bearing stand includes a support frame comprising a pair of extendable rod sets. Each rod set includes a first rod having a first rod upper end and a first rod lower end, a second rod having a second rod upper end and a second rod lower end. Each rod set includes a scissors joint disposed along a portion of the first rod between the first rod upper end. The scissors joint is disposed along a portion of the second rod between the second rod upper end and the second rod lower end wherein the first rod and second rod are rotatable about the scissors joint. Each rod set includes a locking arm rotatably attached to the first rod between the scissors joint and the concave platform along a locking arm first end and including an arm notch adjacent the locking arm second end opposite the locking arm first end wherein the locking arm secures the support frame in a fixed position when the arm notch is engaged with the second rod between the scissors joint and the concave platform. Each of the first rod and the second rod are extendible from a collapsed position to an extended position. Each of the pair of extendable rod sets is storable in the underside cavity when the first rod and the second rod are in the collapsed position. Each of the pair of extendible rod sets are attachable to the concave platform along the first and second rod upper end. The concave platform is height adjustable by extending or collapsing each of the first and second rods of the pair of extendable rod sets. The scissors joint may be a pin joint.

The adjustable pet bearing stand may include at least one LED lamp attached to a portion of the concave platform and a power source for supplying power to the LED lamp. The adjustable pet bearing stand may include at least one LED lamp attached to a portion of the support frame and a power source for supplying power to the LED lamp. The power source may be a transformer powered by an electrical outlet or may be a battery. The first and second rod each may include an upper tube having an upper tube inner diameter and a lower tube having a lower tube outer diameter smaller than the upper tube inner diameter. The lower tube may be slidable within the upper tube wherein the height of the concave platform is adjustable by sliding each lower tube in an upward or downward direction relative to the upper tube engaged therewith. Each of the upper tubes may include a plurality of spaced apart holes and each of the lower tubes includes a compressible protrusion engageable with the plurality of spaced apart holes wherein the lower tubes are lockable in a plurality of positions relative to the upper tubes. The adjustable pet bearing stand may include storage clips disposed on the underside cavity wherein the upper tubes and lower tubes are securable in the storage clips when the lower tubes are separated from the upper tubes. The adjustable pet bearing stand includes a plurality of storage clips disposed on the underside cavity wherein the upper tubes are securable in the storage clips when the lower tubes are fully inserted in the upper tubes.

Another aspect of the present invention is directed to an adjustable pet bearing camping stand comprising a water-resistant concave platform. The water-resistant concave platform includes a perimeter, a depression positioned within the platform perimeter wherein a pet can be placed in the depression, a sidewall extending downward from the platform perimeter, an underside cavity and a sloped protrusion extending upwardly along a portion of the concave platform. The adjustable pet bearing camping stand includes a water-resistant support frame comprising a pair of extendable rod sets. Each rod set includes a first rod having a first rod upper end and a first rod lower end, a second rod having a second rod upper end and a second rod lower end. Each rod set includes a scissors joint disposed along a portion of the first rod between the first rod upper end and the scissors joint disposed along a portion of the second rod between the second rod upper end and the second rod lower end wherein the first rod and second rod are rotatable about the scissors joint. Each rod set includes a locking arm rotatably attached to the first rod between the scissors joint and the concave platform along a locking arm first end and including an arm notch adjacent the locking arm second end opposite the locking arm first end wherein the locking arm secures the support frame in a fixed position when the arm notch is engaged with the second rod between the scissors joint and the concave platform. Each of the first rod and the second rod are extendible from a collapsed position to an extended position. The adjustable pet bearing camping stand includes a waterproof bag for storing the water-resistant concave platform and the water-resistant support frame. Each of the pair of extendable rod sets is storable in the underside cavity when the first rod and the second rod are in the collapsed position. Each of the pair of extendible rod sets are attachable to the concave platform along the first and second rod upper end. The concave platform is height adjustable by extending or collapsing each of the first and second rods of the pair of extendable rod sets.

The adjustable pet bearing camping stand may include at least one LED lamp attached to a portion of the water-resistant concave platform and a power source for supplying power to the LED lamp. The adjustable pet bearing camping stand may include at least one LED lamp attached to a portion of the water-resistant support frame and a power source for supplying power to the LED lamp. The power source may be a transformer powered by an electrical outlet or may be a battery. The adjustable pet bearing camping stand may include at least one fastener attached to a portion of the water-resistant concave platform and at least one cable attachable to the at least one fastener for hanging the adjustable pet bearing camping stand from a structure positioned above the adjustable pet bearing camping stand. The adjustable pet bearing camping stand may include at least one fastener attached to a portion of the water-resistant support frame and at least one cable attachable to the at least one fastener for hanging the adjustable pet bearing camping stand from a structure positioned above the adjustable pet bearing camping stand.

These and other objects, features, and advantages of the present invention will become more readily apparent from the attached drawings and the detailed description of the preferred embodiments, which follow.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 is a top front perspective view of the adjustable pet bearing stand with the support frame in the extended position according to the present invention.

FIG. 2 is a top front perspective view of the adjustable pet bearing camping stand with the support frame in a partially extended position according to the present invention.

FIG. 3 is a perspective view of a portion of the support frame including the pivot joint.

FIG. 4 shows the adjustable pet bearing stand having a puppy laying therein and a pet owner at work.

FIG. 5 shows the concave platform according to the present invention.

FIG. 6 shows an underside view of the adjustable pet bearing stand shown in FIG. 1.

FIG. 7 shows the adjustable pet bearing stand in a stored position and being stored under a couch 400.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

The term legs and support frame may be used interchangeably to describe the portion of the invention supporting the concave platform.

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The system keeps the pet bed at a reachable level for a pet owner, allowing him or her to pet their dogs, cats, etc. while working from home. The chair is comprised of a scissor-style set of legs that support a flat rectangular top plate or platform. The platform supports a comfortable polyester pet bed.

Pet owners can unfold the scissor style legs and utilize a metal hinge and screws to support the platform at a desired height. Once a height is selected, a pet bed can be placed on the platform. The dog/cat is now kept at a height near the pet owner while he/she works from home. Pets can be given attention and remain close to their owners while an individual can still effectively complete their work for the day. Once use is over, the system can be folded and compacted, then stored underneath a couch or other desired area.

Exact size, measurement, construction, and design specifications may vary upon further development and manufacturing.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

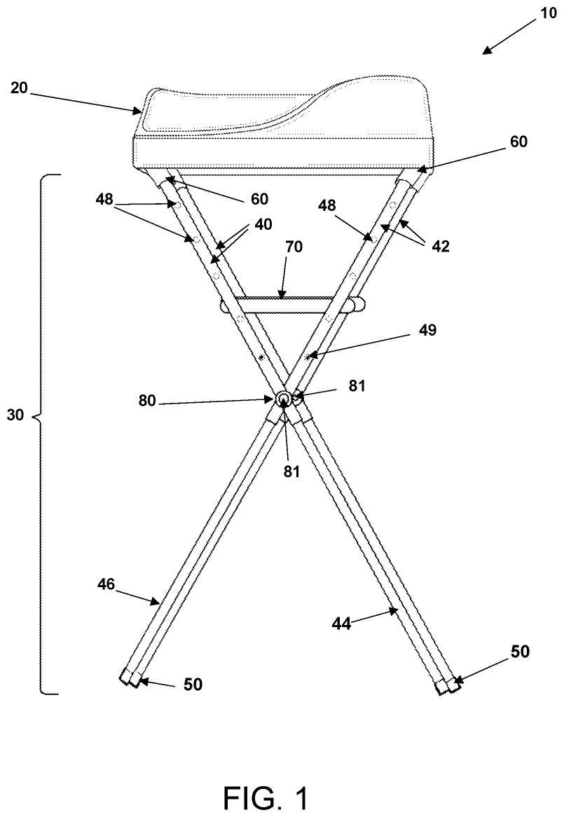

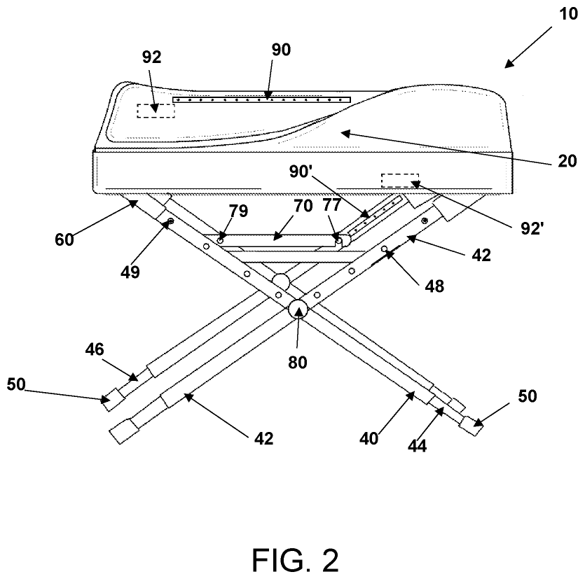

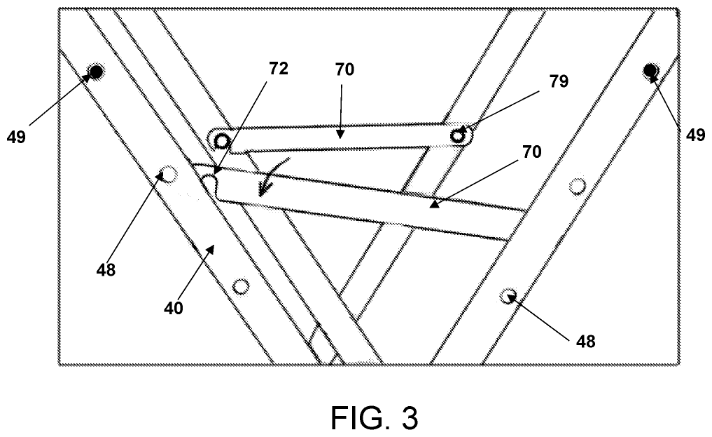

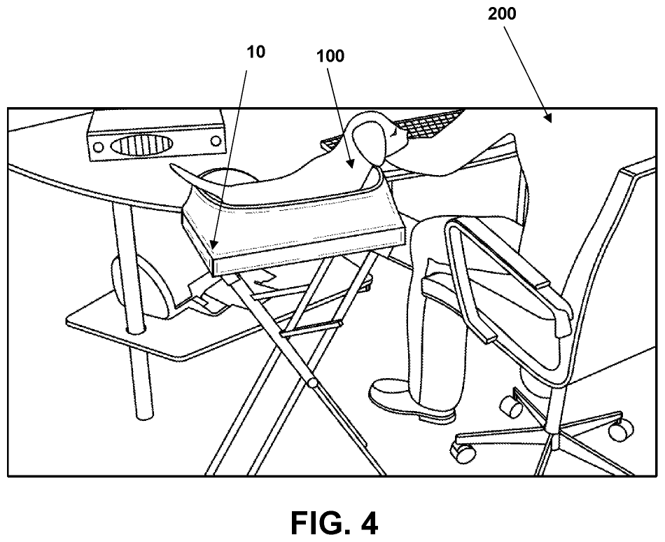

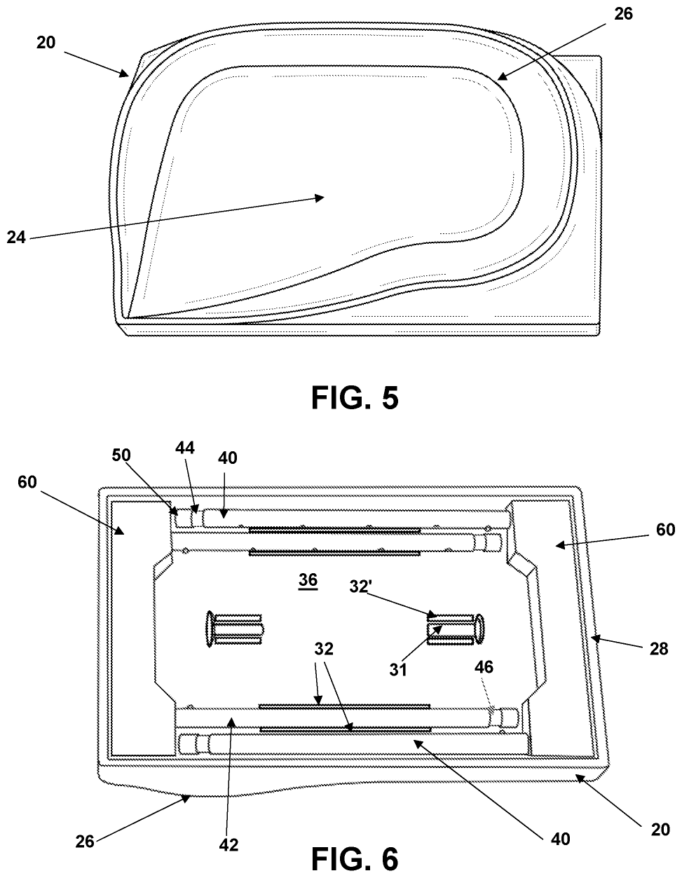

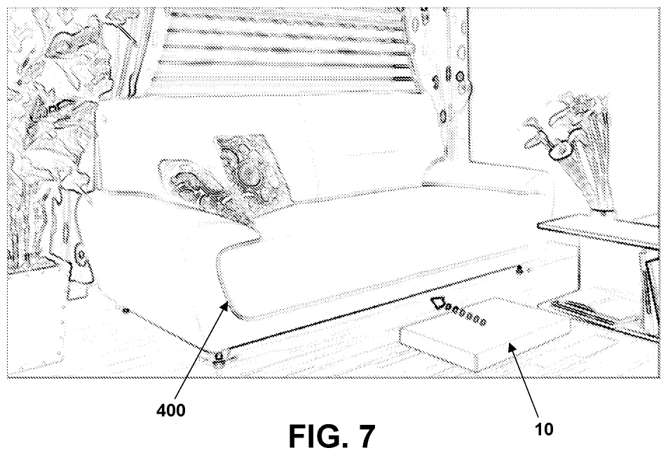

Referring now to the drawings FIGS. 1-7, and more particularly to FIGS. 1 and FIG. 2, there is shown an adjustable pet bearing stand 10 comprising a concave platform 20. FIG. 1 shows the adjustable pet bearing stand 10 in the fully extended position where the concave platform 20 is in its highest position and FIG. 2 shows the adjustable pet bearing stand 10 in the fully extended position where the concave platform 20 is in its highest position. The concave platform shown in FIG. 5 includes a perimeter and a depression 24 positioned within the platform perimeter wherein a pet 100 can be placed in the depression 24. The adjustable pet bearing stand 10 includes a sidewall 28 extending downward from the platform perimeter, an underside cavity 36 and a sloped protrusion 26 extending upwardly along a portion of the concave platform perimeter. The sloped protrusion 26, as seen more clearly on the concave platform 20 in FIG. 6 and the adjustable pet bearing stand 10 in FIG. 4, may extend along at least three sides of the concave platform leaving a space for making pet interaction easier. The sloped protrusion 26 may extend along any portion of the perimeter as long as the sloped protrusion 26 leaves a gap between the sloped protrusion ends. The sloped protrusion 26 may extend more or less that what is provided in the drawings. The adjustable pet bearing stand 10 includes a support frame 30 comprising a pair of extendable rod sets. The first and second rod each include an upper tube 40, 42 having an upper tube inner diameter and a lower tube 44, 46 having a lower tube outer diameter smaller than the upper tube inner diameter. The lower tube 44,46 is slidable within the upper tube 40, 42. The height of the concave platform 20 is adjustable by sliding each lower tube 44, 46 in an upward or downward direction relative to the upper tube 40, 42 engaged therewith. Each of the upper tubes 40, 42 includes a plurality of spaced apart holes 48 and each of the lower tubes 44, 46 includes a compressible protrusion 49 engageable with the plurality of spaced apart holes 48 wherein the lower tube 44, 46 is lockable in a plurality of positions. Rubber feet covers 50 are disposed on the lower end of the tubes 44, 46 to protect from sliding and from dirt and debris. FIG. 6 shows the support stand 30 in the stored position in the underside cavity 36. A pair of pivotable upper supports 60 are rotatably attached to the sidewalls 28. The upper tubes 40, 42 are attached to the upper supports 60 at the upper end of the upper tube 40, 42 and the lower tubes 44, 46 are fully retracted in the upper tubes 40, 42 for storage. Storage clips 32 secure the support stand in the stored position. The upper tubes 40, 42 may be removed from the storage clips 32 by urging the upper tubes 40, 42 away from the storage clips 32. FIG. 7 shows the adjustable pet bearing stand 10 with the stand 30 disassembled and stored in the underside cavity (FIG. 6). The pivot joint or scissors joint 80 secures the rod sets with a pivot pin 81 which may be stored in the underside cavity with a storage clip 32′. Each rod set includes a first rod having a first rod upper end and a first rod lower end, a second rod having a second rod upper end and a second rod lower end. Each rod set includes a scissors joint 80 disposed along a portion of the upper tube 40, 42 between the upper tube upper end and the scissors joint 80 disposed along a portion of the second rod between the second rod upper end and the second rod lower end wherein the first rod and second rod are rotatable about the scissors joint 80. As shown in FIG. 3, each rod set includes a locking arm 70 rotatably attached to the first rod between the scissors joint 80 and the concave platform 20 along a locking arm first end 71 and including an arm notch 72 adjacent the locking arm second end 73 opposite the locking arm first end 71 wherein the locking arm secures the support frame in a fixed position when the arm notch 72 is engaged with a notch pin 77 on the second rod between the scissors joint and the concave platform. Each of the first rod and the second rod are extendible from a collapsed position to an extended position. Each of the pair of extendable rod sets is storable in the underside cavity 36 when the first rod and the second rod are in the collapsed position. Each of the pair of extendible rod sets are attachable to the concave platform 20 along the first and second rod upper end. The concave platform 20 is height adjustable by extending or collapsing each of the first and second rod of the pair of extendable rod sets. The scissors joint 80 may be a pin joint or any joint which allows the first and second rod to open and close as a pair of scissors. FIG. 4 shows the adjustable pet bearing stand 10 with a pet 100 and the pet owner 200 at work. The adjustable pet bearing stand 10 includes a plurality of storage clips 32 disposed on the underside cavity 36 wherein the upper tubes 40, 42 are securable in the storage clips 32 when the lower tubes 44, 46 are fully inserted in the upper tubes 40, 42.

The adjustable pet bearing stand includes at least one LED lamp 90 attached to a portion of the concave platform 20 and a power source 92 for supplying power to the LED lamp 90. In an alternate LED lamp, the LED lamp 92′ is attached to a portion of the support frame 30. The power source 92′ is a transformer powered by an electrical outlet or a battery.

In another embodiment of the present invention is an adjustable pet bearing camping stand 10′ comprising a water-resistant concave platform having a perimeter, a depression 24 positioned within the platform perimeter wherein a pet 100 can be placed in the depression 24, a sidewall 28 extending downward from the platform perimeter, an underside cavity 36 and a sloped protrusion 26 extending upwardly along a portion of the concave platform 20. The adjustable pet bearing camping stand 10′ includes a water-resistant support frame 30 comprising a pair of extendable rod sets, each rod set including a first rod having a first rod upper end and a first rod lower end, a second rod having a second rod upper end and a second rod lower end. The water-resistant support frame 30 includes a scissors joint disposed along a portion of the first rod between the first rod upper end and the scissors joint disposed along a portion of the second rod between the second rod upper end and the second rod lower end. The first rod and second rod are rotatable about the scissors joint 80. The water-resistant support frame 30 includes a locking arm 70 rotatably attached to the first rod between the scissors joint 80 and the concave platform 20 along a locking arm first end 71 and including an arm notch 72 adjacent the locking arm second end 73 opposite the locking arm first end 71. The locking arm 70 secures the support frame 30 in a fixed position when the arm notch 72 is engaged with the second rod between the scissors joint and the concave platform. Each of the first rod and the second rod are extendible from a collapsed position to an extended position. Each of the pair of extendable rod sets is storable in the underside cavity 36 when the first rod and the second rod are in the collapsed position. Each of the pair of extendible rod sets are attachable to the concave platform 20 along the first and second rod upper end. The concave platform 20 is height adjustable by extending or collapsing each of the first rod and second rod of the pair of extendable rod sets. The scissors joint 80 may be a pin joint or any joint which allows the first rod and second rod to open and close as a pair of scissors. The adjustable pet bearing camping stand includes a waterproof bag 300 for storing the water-resistant concave platform 20 and the water-resistant support frame 30. The adjustable pet bearing camping stand includes at least one LED lamp 90, 90′ attached to a portion of the water-resistant concave platform or the water-resistant support frame and includes a power source 92, 92′ for supplying power to the LED lamp 90, 90′. The power source 92, 92′ may be a battery or a transformer powered by an electrical outlet. The adjustable pet bearing camping stand 10′ includes at least one fastener 400 attached to a portion of the water-resistant concave platform and at least one cable 410 attachable to the at least one fastener 400 for hanging the adjustable pet bearing camping stand from a structure positioned above the adjustable pet bearing camping stand 10′. The first and second rod each include an upper tube 40, 42 having an upper tube inner diameter and a lower tube 44, 46 having a lower tube outer diameter smaller than the upper tube inner diameter. The lower tube 44,46 is slidable within the upper tube 40, 42. The height of the concave platform 20 is adjustable by sliding each lower tube 44, 46 in an upward or downward direction relative to the upper tube 40, 42 engaged therewith. Each of the upper tubes 40, 42 includes a plurality of spaced apart holes 48 and each of the lower tubes 44, 46 includes a compressible protrusion 49 engageable with the plurality of spaced apart holes 48 wherein the lower tube 44, 46 is lockable in a plurality of positions. FIG. 6 shows the support stand 30 in the stored position in the underside cavity 36. A pair of pivotable upper supports 60 are rotatably attached to the sidewalls 28. The upper tubes 40, 42 are attached to the upper supports 60 at the upper end of the upper tube 40, 42 and the lower tubes 44, 46 are fully retracted in the upper tubes 40, 42 for storage. Storage clips 32 secure the support stand in the stored position. The upper tubes 40, 42 may be removed from the storage clips 32 by urging the upper tubes 40, 42 away from the storage clips 32. FIG. 7 shows the adjustable pet bearing stand 10 with the stand 30 disassembled and stored in the underside cavity (FIG. 6).

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An adjustable pet bearing stand comprising:
a concave platform having:
a perimeter;
a depression positioned within the concave platform perimeter wherein a pet can be placed in the depression;
a sidewall extending downward from the concave platform perimeter;
an underside cavity; and
a sloped protrusion extending upwardly along a portion of the concave platform perimeter; and
a support frame comprising a pair of extendable rod sets, each rod set including:
a first rod having a first rod upper end and a first rod lower end, a second rod having a second rod upper end and a second rod lower end;
a scissors joint disposed along a portion of the first rod between the first rod upper end and the scissors joint disposed along a portion of the second rod between the second rod upper end and the second rod lower end wherein the first rod and second rod are rotatable about the scissors joint; and
a locking arm rotatably attached to the first rod between the scissors joint and the concave platform along a locking arm first end and including an arm notch adjacent the locking arm second end opposite the locking arm first end wherein the locking arm secures the support frame in a fixed position when the arm notch is engaged with the second rod between the scissors joint and the concave platform;
wherein each of the first rod and the second rod are extendible from a collapsed position to an extended position;
wherein each of the pair of extendable rod sets is storable in the underside cavity when the first rod and the second rod are in the collapsed position;
wherein each of the pair of extendible rod sets are attachable to the concave platform along the first and second rod upper end; and
wherein the concave platform is height adjustable by extending or collapsing each of the first and second rods of the pair of extendable rod sets.

2. The adjustable pet bearing stand according to claim 1 wherein the scissors joint is a pin joint including a pin extending through the pin joint.

3. The adjustable pet bearing stand according to claim 1 including at least one LED lamp attached to a portion of the concave platform and a power source for supplying power to the LED lamp.

4. The adjustable pet bearing stand according to claim 1 including at least one LED lamp attached to a portion of the support frame and a power source for supplying power to the LED lamp.

5. The adjustable pet bearing stand according to claim 3 wherein the power source is a transformer powered by an electrical outlet.

6. The adjustable pet bearing stand according to claim 3 wherein the power source is a battery.

7. The adjustable pet bearing stand according to claim 4 wherein the power source is a transformer powered by an electrical outlet.

8. The adjustable pet bearing stand according to claim 4 wherein the power source is a battery.

9. The adjustable pet bearing stand according to claim 1 wherein the first and second rod each include:
an upper tube having an upper tube inner diameter; and
a lower tube having a lower tube outer diameter smaller than the upper tube inner diameter;
wherein the lower tube is slidable within the upper tube; and
wherein the height of the concave platform is adjustable by sliding each lower tube in an upward or downward direction relative to the upper tube engaged therewith.

10. The adjustable pet bearing stand according to claim 9 wherein each of the upper tubes includes a plurality of spaced apart holes and each of the lower tubes includes a compressible protrusion engageable with the plurality of spaced apart holes wherein the lower tubes are lockable in a plurality of positions relative to the upper tubes.

11. The adjustable pet bearing stand according to claim 10 including a plurality of storage clips disposed on the underside cavity wherein the upper tubes are securable in the storage clips when the lower tubes are fully inserted in the upper tubes.

12. The adjustable pet bearing stand according to claim 10 wherein the scissors joint is a pin joint including a pin extending through the pin joint and the pin is storable in at least one of the plurality of storage clips.

13. An adjustable pet bearing camping stand comprising:
a water-resistant concave platform having:
a perimeter;
a depression positioned within the concave platform perimeter wherein a pet can be placed in the depression;
a sidewall extending downward from the platform perimeter;
an underside cavity; and
a sloped protrusion extending upwardly along a portion of the concave platform perimeter;
a water-resistant support frame comprising a pair of extendable rod sets, each rod set including:
a first rod having a first rod upper end and a first rod lower end, a second rod having a second rod upper end and a second rod lower end;
a scissors joint disposed along a portion of the first rod between the first rod upper end and the scissors joint disposed along a portion of the second rod between the second rod upper end and the second rod lower end wherein the first rod and second rod are rotatable about the scissors joint; and
a locking arm rotatably attached to the first rod between the scissors joint and the concave platform along a locking arm first end and including an arm notch adjacent the locking arm second end opposite the locking arm first end wherein the locking arm secures the support frame in a fixed position when the arm notch is engaged with the second rod between the scissors joint and the concave platform;
wherein each of the first rod and the second rod are extendible from a collapsed position to an extended position; and
a waterproof bag for storing the water-resistant concave platform and the water-resistant support frame;
wherein each of the pair of extendable rod sets is storable in the underside cavity when the first rod and the second rod are in the collapsed position;
wherein each of the pair of extendible rod sets are attachable to the concave platform along the first and second rod upper end; and
wherein the concave platform is height adjustable by extending or collapsing each of the first and second rods of the pair of extendable rod sets.

14. The adjustable pet bearing camping stand according to claim 13 including at least one LED lamp attached to a portion of the water-resistant concave platform and a power source for supplying power to the LED lamp.

15. The adjustable pet bearing camping stand according to claim 13 including at least one LED lamp attached to a portion of the water-resistant support frame and a power source for supplying power to the LED lamp.

16. The adjustable pet bearing camping stand according to claim 13 including at least one fastener attached to a portion of the water-resistant concave platform and at least one cable attachable to the at least one fastener for hanging the adjustable pet bearing camping stand from a structure positioned above the adjustable pet bearing camping stand.

17. The adjustable pet bearing camping stand according to claim 13 including at least one fastener attached to a portion of the water-resistant support frame and at least one cable attachable to the at least one fastener for hanging the adjustable pet bearing camping stand from a structure positioned above the adjustable pet bearing camping stand.

18. An adjustable pet bearing stand comprising:
a concave platform having:
a perimeter;
a depression positioned within the concave platform perimeter wherein a pet can be placed in the depression;
a sidewall extending downward from the concave platform perimeter; and
an underside cavity;
a support frame comprising a pair of extendable rod sets, each rod set including:
a first rod having a first rod upper end and a first rod lower end, a second rod having a second rod upper end and a second rod lower end;
a scissors joint disposed along a portion of the first rod between the first rod upper end and the scissors joint disposed along a portion of the second rod between the second rod upper end and the second rod lower end wherein the first rod and second rod are rotatable about the scissors joint; and
a locking arm rotatably attached to the first rod between the scissors joint and the concave platform along a locking arm first end and including an arm notch adjacent the locking arm second end opposite the locking arm first end wherein the locking arm secures the support frame in a fixed position when the arm notch is engaged with the second rod between the scissors joint and the concave platform;
wherein each of the first rod and the second rod are extendible from a collapsed position to an extended position;
wherein each of the pair of extendable rod sets is storable in the underside cavity when the first rod and the second rod are in the collapsed position;
wherein each of the pair of extendible rod sets are attachable to the concave platform along the first and second rod upper end; and
wherein the concave platform is height adjustable by extending or collapsing each of the first and second rods of the pair of extendable rod sets.
